(19) United States
(12) Patent Application Publication
(10) Pub. No.: US 2013/0043071 A1
(43) Pub. Date: Feb. 21, 2013

(54) THERMAL ENERGY MANAGEMENT COMPONENT AND SYSTEM INCORPORATING THE SAME

(71) Applicants: Pradip Radhakrishnan Subramaniam, Bangalore (IN); Thangavelu Asokan, Bangalore (IN); Sudhakar Eddula Reddy, Bangalore (IN); Sandeep Dhar, Bangalore (IN)

(72) Inventors: Pradip Radhakrishnan Subramaniam, Bangalore (IN); Thangavelu Asokan, Bangalore (IN); Sudhakar Eddula Reddy, Bangalore (IN); Sandeep Dhar, Bangalore (IN)

(73) Assignee: GENERAL ELECTRIC COMPANY, Schenectady, NY (US)

(21) Appl. No.: 13/211,808

(22) Filed: Aug. 17, 2011

(51) Int. Cl. H02G 5/10

(52) U.S. Cl. 174/70 B

(57) ABSTRACT

An apparatus is provided that includes a heat pipe and a heat sink that includes a foam (e.g., a metal foam, a carbon foam, and/or a graphite foam) and is configured to exchange thermal energy with the heat pipe. For example, the heat pipe can include a thermal energy receiving portion and a thermal energy rejecting portion. The heat sink can be configured to receive thermal energy from a busbar and the thermal energy receiving portion can be configured to receive thermal energy from said heat sink. Alternatively, the thermal energy receiving portion can be configured to receive thermal energy from a busbar, and the heat sink can be configured to receive thermal energy from the thermal energy rejecting portion.

### BACKGROUND

The subject matter disclosed herein generally relates to thermal management and particularly to thermal management of busbars.

Power distribution in a high current environment requires current flow from a power supply to various components, for example, drive systems, motors, electrical loads, amplifiers, rectifiers, routers, servers, etc. Among the more common methods used to supply power are heavy gauge wire and cable, switchgears, circuit boards, and busbars.

Typically, power distribution has involved one or more heavy copper busbars that are provided with connectors or holes for connecting cables. Busbars might be spaced apart from each other and isolated by insulating spacers. Large copper or aluminum busbars and cables have been used to distribute power within industrial control systems. Such busbars are large and can carry high power relatively easily. Traditionally, busbars cooling techniques involved circulating air within a cabinet to cool the busbars. In systems requiring isolation, busbars are located remotely and coupled via cables to other components. However, as power distribution systems require higher operating current densities, increasing the power density through the busbars has challenges such as airflow and ventilation, vibration, noise, and efficient use of space.

### BRIEF DESCRIPTION

In one aspect, an apparatus is provided that includes a heat pipe and a heat sink that includes a foam (e.g., a metal foam, a carbon foam, and/or a graphite foam) and is configured to exchange thermal energy with the heat pipe. For example, the heat pipe can include a thermal energy receiving portion and a thermal energy rejecting portion. The heat sink can be configured to receive thermal energy from a busbar and the thermal energy receiving portion can be configured to receive thermal energy from said heat sink. Alternatively, the thermal energy receiving portion can be configured to receive thermal energy from a busbar (e.g., by being physically coupled to the busbar, perhaps at a joint thereof), and the heat sink can be configured to receive thermal energy from (e.g., by being physically coupled to) the thermal energy rejecting portion.

In one embodiment, the foam can define pores having respective diameters less than or about equal to 200 μm. A coating can be disposed on the foam, the coating having a thermal conductivity at 300 K of greater than or about equal to 300 W/m·K.

In another aspect, an apparatus is provided that includes a busbar and a thermal energy management component configured to receive thermal energy from the busbar. The thermal energy management component can include a heat pipe and a heat sink that includes a metal foam and is configured to exchange thermal energy with the heat pipe.

In yet another aspect, an apparatus is provided that includes an electrical component and a thermal energy management component configured to receive thermal energy from the electrical component. The thermal energy management component can include a heat pipe and a heat sink configured to exchange thermal energy with said heat pipe, said heat sink including a metal foam.

### DRAWINGS

FIG. 1 is a perspective view of a busbar.

FIG. 2 is an exploded view of the busbar of FIG. 1.

FIG. 3 is a perspective view of the busbar of FIG. 1 along with a thermal energy management component configured in accordance with an example embodiment.

FIG. 4 is a perspective, partially exploded view of the busbar and thermal energy management component of FIG. 3.

FIG. 5 is a side view of the busbar and thermal energy management component of FIG. 3, taken along direction 2 in FIG. 3.

FIG. 6 is a side view of the busbar and thermal energy management component of FIG. 3, taken along direction 1 in FIG. 3.

FIG. 7 is a magnified view of the area labeled “7” in FIG. 3.

FIG. 8 is a side view of the busbar and thermal energy management component of FIG. 3, taken along direction 2 in FIG. 3, schematically depicting the flow of thermal energy.

FIG. 9 is a perspective view of a busbar along with a thermal energy management component configured in accordance with another example embodiment.

FIG. 10 is a magnified view of the area labeled “10” in FIG. 9.

FIGS. 11-14 are side views of respective thermal energy management components configured in accordance with other example embodiments.

FIG. 15 is a perspective view of a busbar along with a thermal energy management component configured in accordance with another example embodiment.

FIG. 16 is a side view of the busbar and thermal energy management component of FIG. 15, taken along direction 2 in FIG. 15.

FIG. 17 is a side view of the busbar and thermal energy management component of FIG. 15, taken along direction 1 in FIG. 15.

FIG. 18 is a magnified view of the area labeled “18” in FIG. 15.

FIG. 19 is a perspective view of a busbar, heat sink, and heat pipes.

FIG. 20 is a side view of the busbar, heat sink, and heat pipes of FIG. 19, taken along direction 2 of FIG. 19.

FIG. 21 is a perspective view of a busbar along with a thermal energy management component configured in accordance with another example embodiment.

### DETAILED DESCRIPTION

Example embodiments are described below in detail with reference to the accompanying drawings, where the same reference numerals denote the same parts throughout the drawings. Some of these embodiments may address the above and other needs.

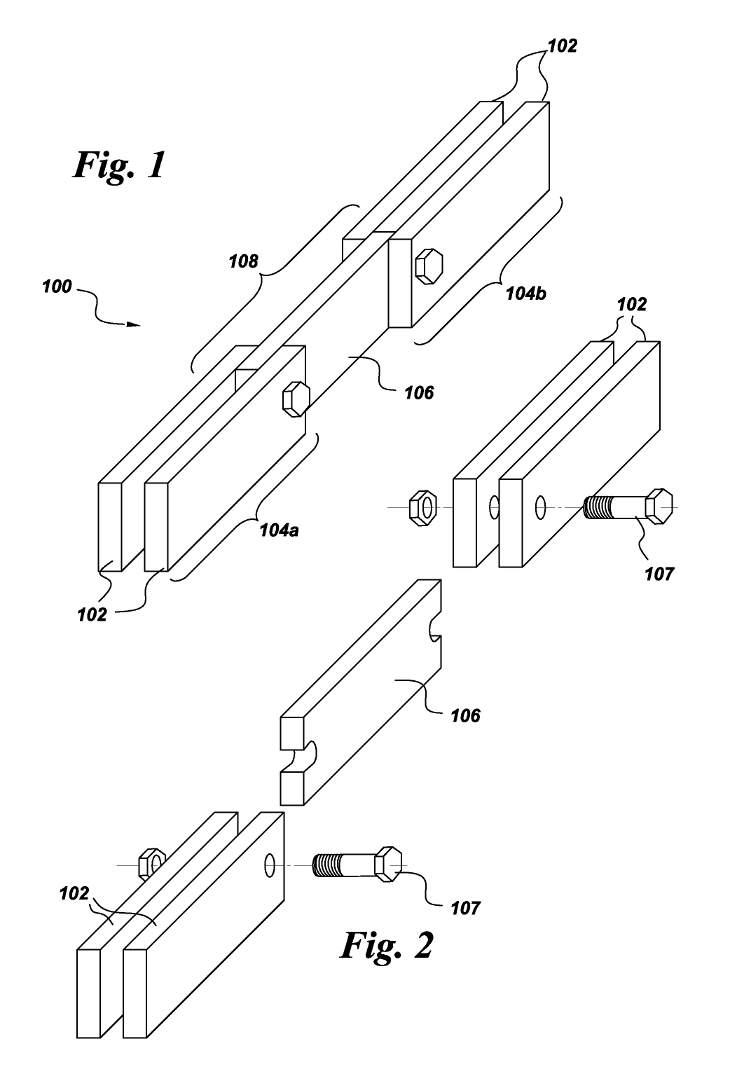

Referring to FIGS. 1 and 2, therein is shown an electrical component, such as, for example, a busbar 100. The busbar 100 can include a pair of opposing metal plates 102 that can serve to conduct electricity. The busbar 100 can include discrete busbar sections 104a, 104b. Adjacent busbar sections 104a, 104b can be mechanically and electrically coupled using a connector 106 (for example, in conjunction with bolts 107), thereby forming a busbar joint 108.

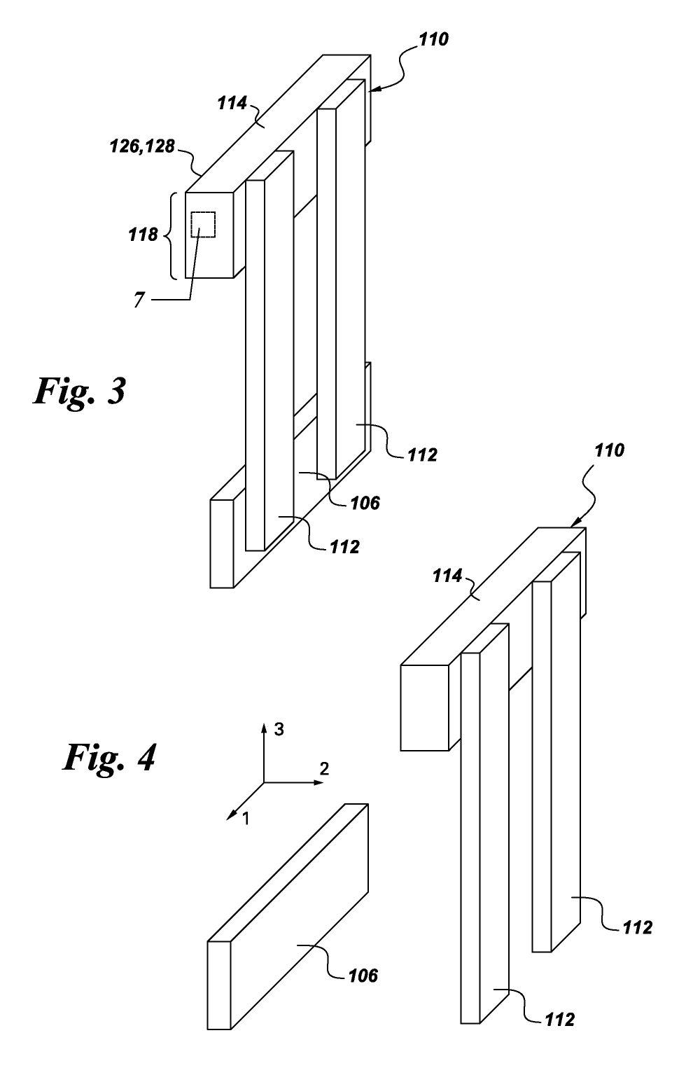

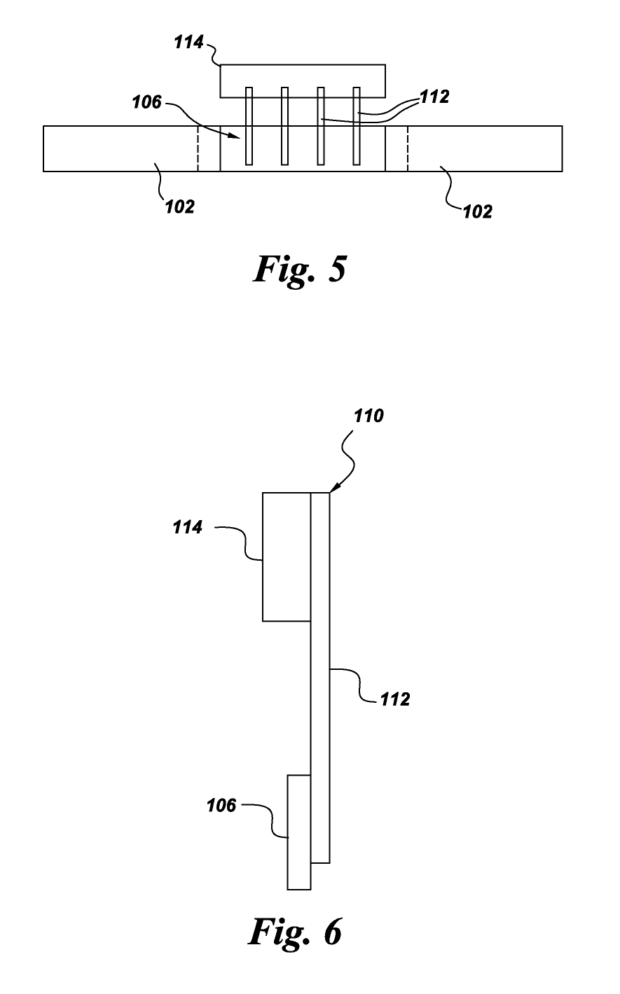

Referring to FIGS. 3-7, a thermal energy management component 110 can be configured to receive thermal energy from the busbar 100. For example, the thermal energy management component 110 can be configured to receive thermal energy from the busbar joint 108. The thermal energy management component 110 can include one or more heat pipes 112 and a heat sink 114, which are described in more detail below.

Each of the heat pipes 112 can include a thermal energy receiving portion 116 and a thermal energy rejecting portion 118. The thermal energy receiving portion 116 can be configured to receive thermal energy from the busbar 100, such as by physically coupling the thermal energy receiving portion to the busbar (e.g., to the connector 106 at the joint 108), say, via solder (e.g., silver paste or some other material with relatively high thermal conductivity; not shown) or a thermal interface material (e.g., a diamond-like carbide coated plate; not shown).

Thermal energy received at the thermal energy receiving portion 116 can be absorbed by a liquid working fluid (not shown) contained within the heat pipe 112 so as to cause evaporation. The resulting working fluid vapor (not shown) can travel through the heat pipe 112 to the thermal energy rejecting portion 118, at which point thermal energy can be removed from the vapor to cause condensation. The condensed liquid working fluid can then return to the thermal energy receiving portion 116 under the influence of gravitational and/or capillary forces.

It is noted that the working fluid utilized by the heat pipe 112 can be any of a variety of substances, depending on the operating conditions under which the heat pipe is to be employed. Specifically, Table 1 below lists some examples of working fluids that can be employed in the heat pipes 112, depending on the operating temperatures of the heat pipe.

TABLE 1

| working fluid | approximate useful range (K) |
|---|---|
| oxygen | 55-154 |
| nitrogen | 65-125 |
| ethane | 100-305 |
| butane | 260-350 |
| methanol | 273-503 |
| toluene | 275-473 |
| acetone | 250-475 |
| ammonia | 200-405 |
| mercury | 280-1070 |
| water | 273-643 |
| potassium | 400-1800 |
| sodium | 400-1500 |
| lithium | 500-2100 |
| silver | 1600-2400 |

The heat sink 114 can be configured to exchange thermal energy with one or more of the heat pipes 112. For example, the heat sink 114 can be configured to receive thermal energy from the thermal energy rejecting portion 118, such as by physically coupling the heat sink to the thermal energy rejecting portion, say, via solder (e.g., silver paste or some other material with relatively high thermal conductivity; not shown) or a thermal interface material (e.g., a diamond-like carbide coated plate; not shown)).

The heat sink 114 can include a foam 120 that defines pores 122 therein. The foam 120 can include, for example, a metal foam (e.g., aluminum, silver, and/or copper, as well as alloys including one or more of these constituents), a carbon foam, and/or a graphite foam, or can include foams formed of other materials of relatively high thermal conductivity. The pores 122 can have respective diameters less than or about equal to 200 μm, and may be arranged so as to form an interconnected network, whereby the interior surfaces 124 of the pores are in contact with the ambient environment. The heat sink 114 can thus have a free surface 126 that includes the external surface 128 of the heat sink and the interior surfaces 124 of the pores 122. It is noted that while the pores 122 are described as having a “diameter,” it is not necessary that the pores be spherical in shape.

The above described foam 120 can be formed in a variety of ways. For example, in one embodiment, a polymer-based foam (e.g., a polyurethane (PU) foam) can be produced, and the polymer-based foam can be coated with metal through plating, vapor deposition, and/or being exposed to (e.g., dip-coated in) a melt slurry. Thereafter, the polymer can be removed, for example, by being burned out/decomposed from within the metal coating. In another embodiment, liquid metal can be bubbled, say, with inert gases or through gas blowing agents added to the liquid metal. The foam 120 can also be produced through powder metallurgy routes, with the metal powder being pressed and sintered along with spacers, gas blowing agents, and/or spherical powder followed by sintering.

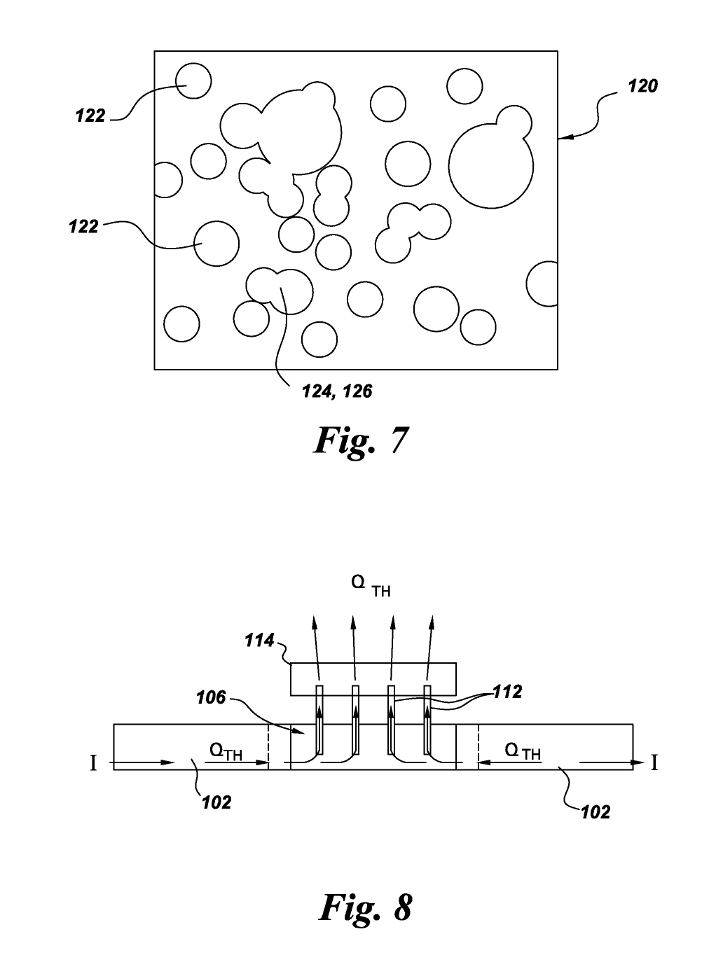

Referring to FIGS. 7 and 8, in operation, as the busbar 100 conducts electric current I therethrough, the resistance of the busbar will result in the generation of thermal energy Q_{TH} via Joule heating of the busbar. This thermal energy Q_{TH} can flow via conduction along the busbar 100 to the heat pipes 112, at which point the thermal energy can be transported from the thermal energy receiving portion 116 to the thermal energy rejecting portion 118. At the thermal energy rejecting portion 118, the thermal energy can be transferred to the heat sink 114.

Due to the porosity of the foam 120 included in the heat sink 114, the heat sink has a relatively large surface area-to-volume ratio. This allows enhanced contact between free surface 126 of the heat sink 114 and the air or other fluids circulating around the heat sink, thereby enhancing the transfer of thermal energy from the heat sink to the surrounding environment. Along these lines, a smaller pore size, and a higher density of pores, may be expected to increase the efficiency of thermal energy transfer from the heat sink 114 to the ambient environment. However, Applicants note that extremely small pores may inhibit the circulation of fluid therethrough, thereby limiting the overall efficiency of heat transfer, and also that very high pore densities may compromise the structural integrity of the heat sink 114. Applicants have observed favorable thermal energy transfer efficiencies when using heat sinks that include foams having pores with diameters of about 200 μm and pore densities greater than or equal to about 60 pores per inch.

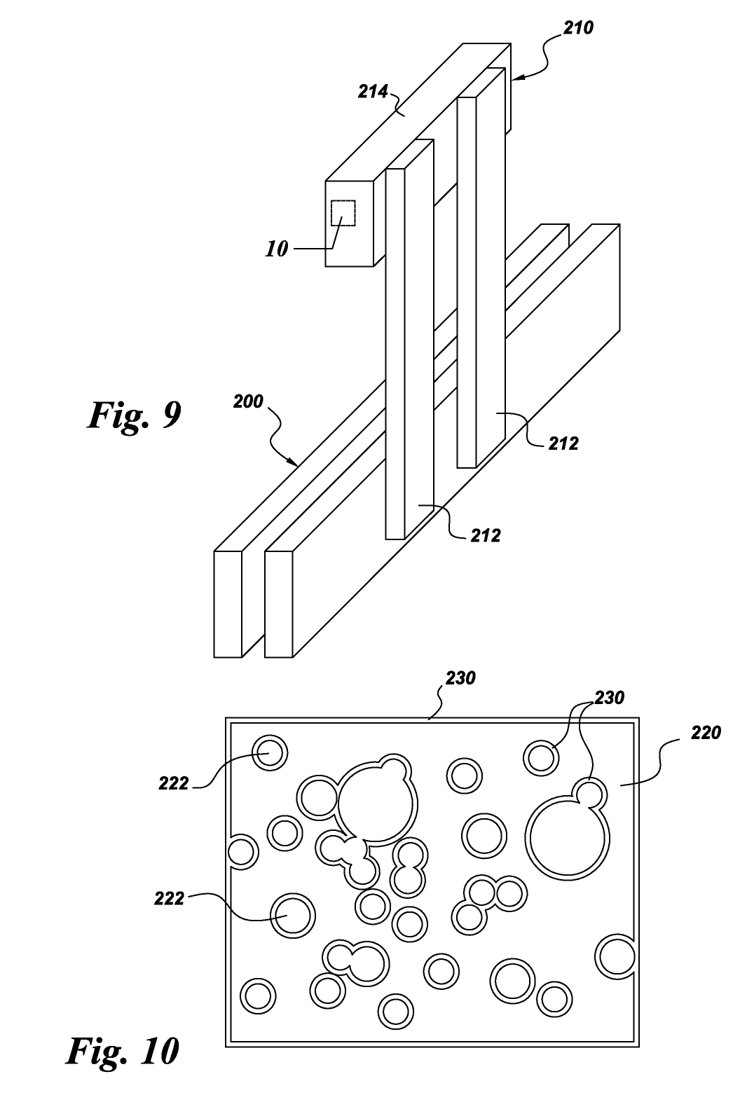

Referring to FIGS. 9 and 10, therein is shown another embodiment of a thermal energy management component 210, the component being attached to and configured to receive thermal energy from a busbar 200. The thermal energy management component 210 can include one or more heat pipes 212 and a heat sink 214. The heat pipes 212 can be configured to receive thermal energy from the busbar 200, and to transfer thermal energy to the heat sink 214.

The heat sink 214 can include a foam 220 that defines pores 222 therein. A coating 230 can be disposed on the foam 220, which coating can have a relatively high thermal conductivity, for example greater than or about equal to 300 W/m·K (when measured at 300 K). Examples of suitable coating materials include, but are not limited to, silver, graphite, and/or diamond/diamond-like material. The coating 230 can be applied via vacuum deposition techniques (e.g., chemical vapor deposition (CVD), metalorganic CVD, pulsed laser deposition, sputtering, etc.) or through slurry coating techniques (e.g., dip coating). The inclusion of a relatively high thermal conductivity coating 230 on the foam 220 may act to enhance the transfer of thermal energy from the heat sink 214 to the surrounding environment.

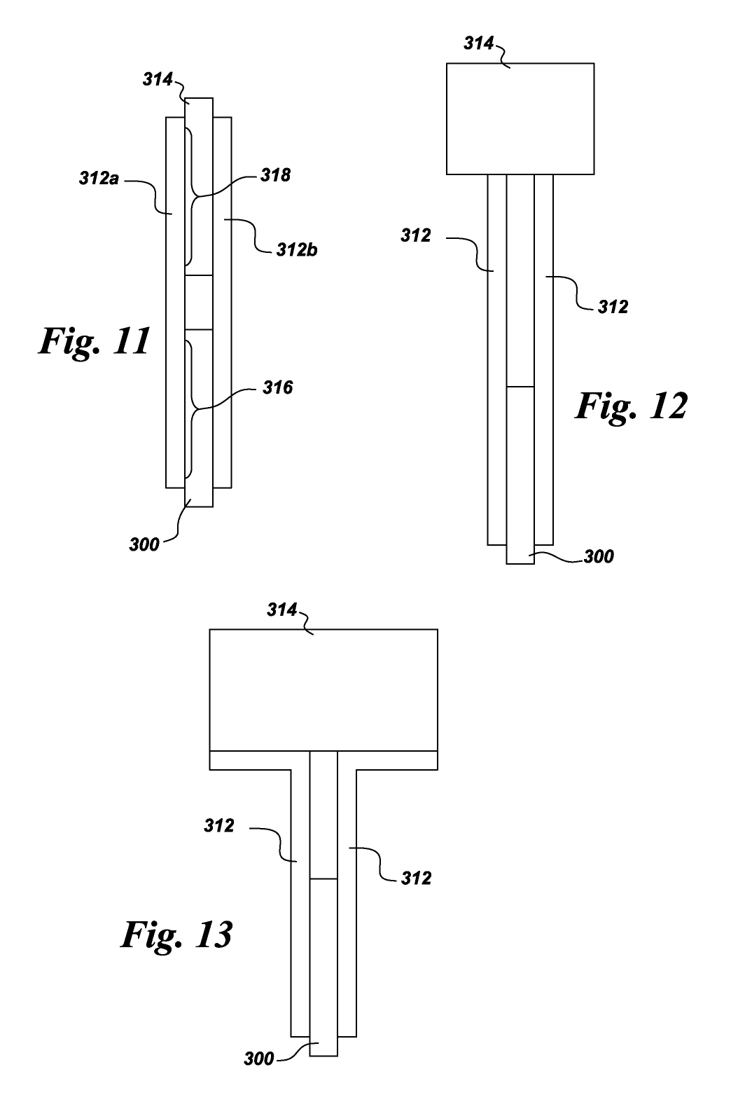

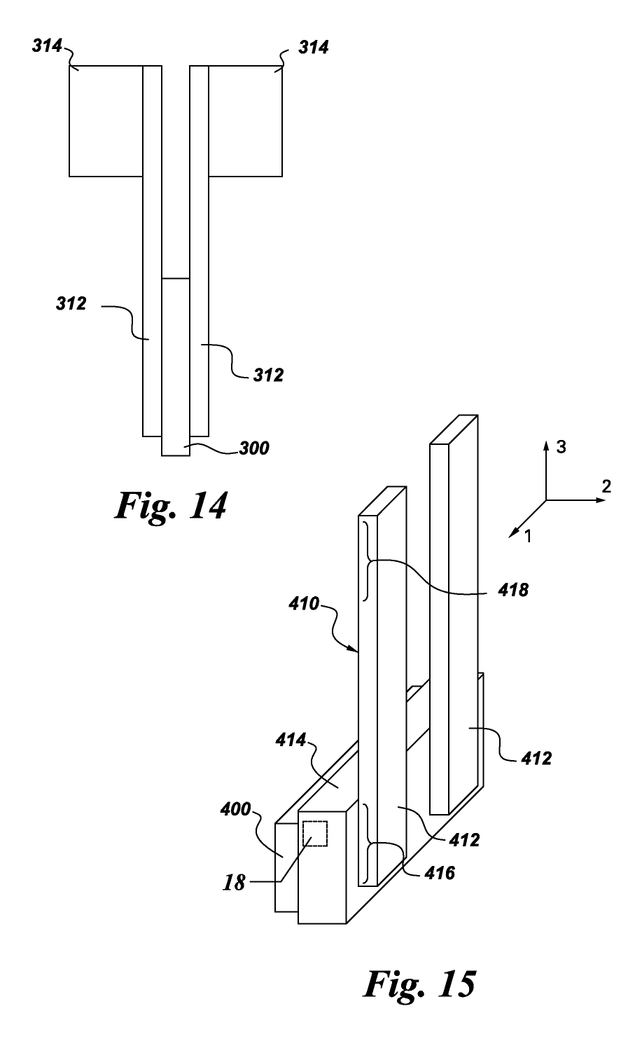

Referring to FIG. 11, therein is shown another embodiment of a thermal energy management component 310. The thermal energy management component 310 can include a first set of heat pipes 312a and a second set of heat pipes 312b, each set being respectively attached to opposing sides of a busbar 300. Each heat pipe 312 can include a thermal energy receiving portion 316 that is configured to receive thermal energy from the busbar 300. The thermal energy can propagate along the heat pipes 312 to be transferred at respective thermal energy rejecting portions 318 to a heat sink 314. The heat sink 314 can include a foam that facilitates heat exchange with the ambient environment. By utilizing opposing sets of heat pipes 312a, 312b, the thermal energy management component 310 may provide enhanced and more uniform thermal energy transfer from the busbar 300. The heat pipes 312 and heat sink(s) 314 can be arranged in a variety of ways, as demonstrated in FIGS. 12-14.

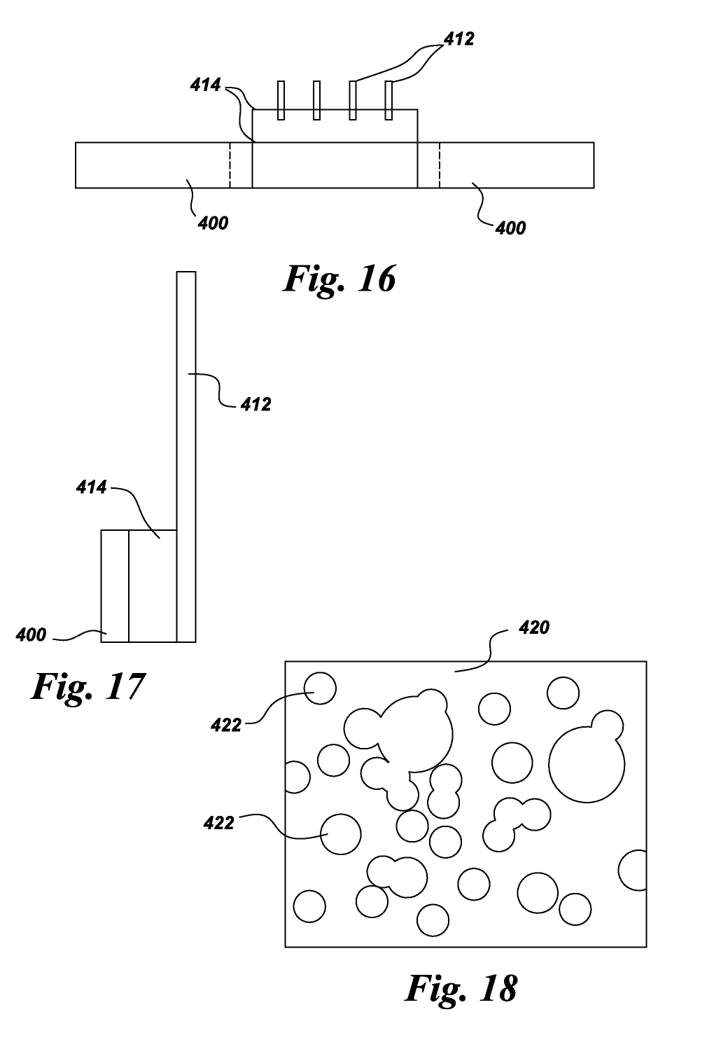

In the above described embodiments, heat pipes are employed as a first stage in removing thermal energy from busbars/electrical components, and heat sinks including foams are utilized in a second stage of heat transfer to the ambient environment. However, in other embodiments, other configurations of heat pipes and foam-containing heat sinks can be utilized. For example, referring to FIGS. 15-18, therein is shown a thermal energy management component 410 configured in accordance with another embodiment. The thermal energy management component 410 can include one or more heat pipes 412 and a heat sink 414 that can be configured to exchange thermal energy.

The heat sink 414 can be configured to receive thermal energy from a busbar 400, for example, by being physically coupled to the busbar. The heat sink 414 can include a foam 420 that defines pores 422 arranged so as to form an interconnected network. In operation, thermal energy can be transferred from the busbar 400 to the heat sink 414. Some thermal energy can be rejected by the heat sink 414 to the ambient environment. Other thermal energy can be transferred to the heat pipes 412 via thermal energy receiving portions 416, which can be physically coupled to the heat sink. Thermal energy received at the thermal energy receiving portion 416 can be transferred through the heat pipe 412 to the thermal energy rejecting portions 418, at which point thermal energy can be removed to the ambient environment.

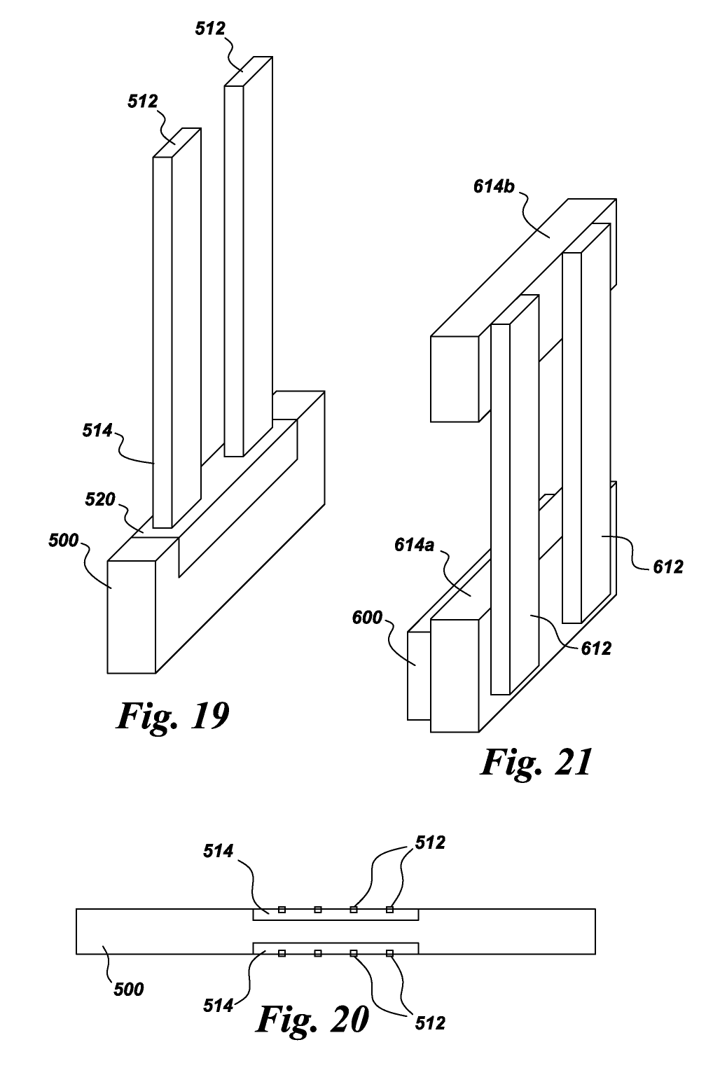

Referring to FIGS. 19 and 20, therein is shown a busbar 500. A heat sink 514 including a foam 520 can be integrated into the busbar 500. For example, the busbar 500 may be made of copper, and the foam-including heat sink 514 can be formed by shaping the busbar so as to accommodate the foam 520, and then inserting the foam into the busbar and joining the foam and busbar through brazing/welding, thermal paste, and/or soldering with low melting temperature alloys. As part of the joining process, any mating surfaces between the busbar 500 and the foam 520 can be roughened to enhance adhesion. Heat pipes 512 can be coupled to or embedded in the heat sink 514 to allow thermal energy to be transferred away from the busbar 500.

Referring to FIG. 21, therein is shown a thermal energy management component 610 configured in accordance with another embodiment. A first heat sink 614a can be configured to receive thermal energy from a busbar 600, for example, by being physically coupled to the busbar. The first heat sink 614a can include a foam that defines pores arranged so as to form an interconnected network. In operation, thermal energy can be transferred from the busbar 600 to the first heat sink 614a. Some thermal energy can be rejected by the first heat sink 614a to the ambient environment. Other thermal energy can be transferred to the heat pipes 612 via thermal energy receiving portions 616, which can be physically coupled to the heat sink. Thermal energy received at the thermal energy receiving portion 616 can be transferred through the heat pipe 612 to the thermal energy rejecting portions 618, at which point thermal energy can be transferred to a second foam-containing heat sink 614b. The second foam-containing heat sink 614b can include an interconnected network of pores to facilitate removal of thermal energy to the ambient environment.

While only certain features of the invention have been illustrated and described herein, many modifications and changes will occur to those skilled in the art. It is, therefore, to be understood that the appended claims are intended to cover all such modifications and changes as fall within the true spirit of the invention.

What is claimed:

1. An apparatus comprising:
a heat pipe; and
a heat sink configured to exchange thermal energy with said heat pipe, said heat sink including a foam.

2. The apparatus of claim 1, wherein said heat pipe includes a thermal energy receiving portion and a thermal energy rejecting portion, and wherein said heat sink is configured to receive thermal energy from a busbar and said thermal energy receiving portion is configured to receive thermal energy from said heat sink.

3. The apparatus of claim 1, wherein said heat pipe includes a thermal energy receiving portion and a thermal energy rejecting portion, said thermal energy receiving portion being configured to receive thermal energy from a busbar, and wherein said heat sink is configured to receive thermal energy from said thermal energy rejecting portion.

4. The apparatus of claim 3, wherein said heat sink is physically coupled to said thermal energy rejecting portion.

5. The apparatus of claim 3, wherein said foam includes at least one of a metal foam, a carbon foam, or a graphite foam.

6. The apparatus of claim 3, wherein said foam defines pores having respective diameters less than or about equal to 200 μm.

7. The apparatus of claim 3, further comprising a coating disposed on said foam and having a thermal conductivity at 300 K of greater than or about equal to 300 W/m·K.

8. The apparatus of claim 3, wherein said thermal energy receiving portion is configured to be physically coupled to the busbar.

9. The apparatus of claim 8, wherein said thermal energy receiving portion is configured to be physically coupled to a joint of the busbar.

10. An apparatus comprising:
a busbar; and
a thermal energy management component configured to receive thermal energy from said busbar, said thermal energy management component including
a heat pipe; and
a heat sink configured to exchange thermal energy with said heat pipe, said heat sink including a metal foam.

11. The apparatus of claim 10, wherein said heat pipe includes a thermal energy receiving portion and a thermal energy rejecting portion, and wherein said heat sink is configured to receive thermal energy from said busbar and said thermal energy receiving portion is configured to receive thermal energy from said heat sink.

12. The apparatus of claim 10, wherein said heat pipe includes a thermal energy receiving portion and a thermal energy rejecting portion, said thermal energy receiving portion being configured to receive thermal energy from said busbar, and wherein said heat sink is configured to receive thermal energy from said thermal energy rejecting portion.

13. The apparatus of claim 12, wherein said heat sink is physically coupled to said thermal energy rejecting portion.

14. The apparatus of claim 12, wherein said foam includes at least one of a metal foam, a carbon foam, or a graphite foam.

15. The apparatus of claim 12, wherein said thermal energy receiving portion is physically coupled to said busbar.

16. The apparatus of claim 15, wherein said thermal energy receiving portion is attached to said busbar via a high thermal conducting media selected from the group consisting of silver and a diamond-like carbide coated plate.

17. The apparatus of claim 15, wherein said thermal energy receiving portion is configured to be physically coupled to a joint of said busbar.

18. An apparatus comprising:
an electrical component; and
a thermal energy management component configured to receive thermal energy from said electrical component, said thermal energy management component including
a heat pipe; and
a heat sink configured to exchange thermal energy with said heat pipe, said heat sink including a metal foam.

19. The apparatus of claim 18, wherein said heat pipe includes a thermal energy receiving portion and a thermal energy rejecting portion, and wherein said heat sink is configured to receive thermal energy from said electrical component and said thermal energy receiving portion is configured to receive thermal energy from said heat sink.

20. The apparatus of claim 18, wherein said heat pipe includes a thermal energy receiving portion and a thermal energy rejecting portion, said thermal energy receiving portion being configured to receive thermal energy from said electrical component, and wherein said heat sink is configured to receive thermal energy from said thermal energy rejecting portion.
